(19) United States
(12) Patent Application Publication
(10) Pub. No.: US 2025/0182517 A1
(43) Pub. Date: Jun. 5, 2025

(54) DETECTION OF BODY PART AND ASSOCIATED BODY IN AN IMAGE

(71) Applicant: Shanghai United Imaging Intelligence Co., Ltd., Shanghai (CN)

(72) Inventors: ZHONGPAI GAO, Rowley, MA (US); Abhishek Sharma, Boston, MA (US); Meng Zheng, Cambridge, MA (US); Benjamin Planche, Briarwood, NY (US); Ziyan Wu, Lexington, MA (US); Yuchun Liu, Shanghai (CN); Fan Yang, Shanghai (CN); Terrence Chen, Lexington, MA (US)

(73) Assignee: Shanghai United Imaging Intelligence Co., Ltd., Shanghai (CN)

(21) Appl. No.: 18/528,150

(22) Filed: Dec. 4, 2023

(51) Int. Cl. G06V 40/10; G06V 10/764; G06V 10/77; G06V 10/82; G06V 40/20

(52) U.S. Cl. CPC G06V 40/10; G06V 10/764; G06V 10/7715; G06V 10/82; G06V 40/28

(57) ABSTRACT

A prediction regarding respective areas of an image that correspond to bodies of people depicted in the image and regarding an area of the image that corresponds to a body part may be made based on a machine learning (ML) model. A vector that points from the area of the image that corresponds to the body part to another area of the image may also be obtained based on the ML model. An association between the body part and one of the depicted people may be determined based at least on the vector and the respective areas of the image that correspond to the bodies of the people depicted in the image. Determining the association between the body part and the one of the people may include determining that the area of the image to which the vector points corresponds to the body of the one of the people.

### BACKGROUND

The detection of human body parts (e.g., hands, face, etc.) and their correct association with individuals (e.g., human bodies) to which they correspond in an image may be an essential task in certain scenarios, such as, e.g., in human-machine interfaces and action recognition systems in a medical setting. As discussed herein, human part-to-body association may refer to the task of detecting (e.g., in an image) human body parts within an image and identifying the corresponding person (e.g., the corresponding body) for each detected body part, e.g., determining that a hand, arm, face, etc. belongs to person A and not person B. Human part-to-body association may be especially important in scenarios where multiple individuals are present and specific gestures from a particular one of the individuals must be recognized and acted upon. An illustrative example of such a scenario may be found in medical scan rooms, where a patient or technician may use hand gestures to indicate the readiness of the patient or a scanning device, in the presence of other people, before initiating the medical scanning process. In such multi-body scenarios, it is crucial that the scanning system respond only to the right person's gestures in order to avoid unintended responses from the scanning system. By achieving this kind of nuanced recognition, part-to-body association may provide benefits across various fields that may benefit from more intuitive and precise control systems, such as, human-computer interaction, virtual reality, robotics, and medical process automation.

### SUMMARY

Described herein are systems, methods, and instrumentalities associated with detecting a human body part and an associated body in an image. An apparatus configured to perform the body part detection and the body part-to-body association may include one or more processors configured to obtain (e.g., from an image sensor inside a medical scanner room) an image of an environment, wherein the image may depict multiple people in the environment, and predict, based on a machine learning (ML) model, respective areas of the image that may correspond to the bodies of the people depicted in the image and an area of the image that corresponds to a body part (e.g., a hand). The apparatus may also obtain, based on the ML model, a vector that points from the area of the image that corresponds to the body part to another area of the image, and determine, based at least on the vector and the respective areas of the image that correspond to the bodies of the people depicted in the image, an association between the body part and one of the people depicted in the image. In some embodiments, the vector may indicate a distance and a direction between the center of the area that corresponds to the body part and the center of the other area to which the vector points.

In some embodiments, the one or more processors being configured to determine the association between the body part and the one of the people depicted in the image may include the one or more processors being configured to determine that the other area of the image, to which the vector points, corresponds to the body of the one of the people. In some embodiments, the areas of the image that correspond to the bodies of the people may include respective bounding boxes around the bodies of the people, and the area of the image that corresponds to the body part may include a bounding box around the body part.

In some embodiments, the one or more processors may be further configured to determine, using the ML model, respective first classification labels for the areas that correspond to the bodies of the people and a second classification label for the area that corresponds to the body part, with the first classification labels indicating that the corresponding areas are body areas and the second classification label indicating that the corresponding area is a body part area. In some embodiments, the association between the body part and the one of the people depicted in the image may be determined further based on the first classification labels and the second classification label.

In some embodiments, the ML model may include a first portion, a second portion, and a third portion. The first portion may be configured to determine respective bounding boxes around the areas of the image that correspond to the bodies of the people and the area of the image that corresponds to the body part. The second portion may be configured to generate classification labels for the bounding boxes determined by the first portion, while the third portion may be configured to determine the vector that points from the area of the image that corresponds to the body part to the other area of the image that corresponds to the body part. In examples, the ML model may be configured to indicate the bounding boxes, the classification labels, and the vector in the same output (e.g., the bounding boxes, classification labels, and vector may be determined via a single stage process).

In some embodiments, the ML model may be implemented via at least one convolutional neural network (CNN). In some embodiments, the CNN may be configured to generate multi-scale feature maps associated with the image and may also be configured to predict the vector that points from the area of the image that corresponds to the body part to the other area of the image based on the multi-scale feature maps.

### BRIEF DESCRIPTION OF THE DRAWINGS

A more detailed understanding of the examples disclosed herein may be had from the following descriptions, given by way of example in conjunction with the accompanying drawings.

FIG. 1 shows a simplified block diagram of an example apparatus that may be used to perform the operations for detecting bodies and a body part in an image of an environment and determining an association between the body part and one of the bodies as described herein.

FIG. 2 shows a simplified diagram illustrating how areas corresponding to a body part and areas corresponding to multiple bodies of people in the image of the environment may be identified and associated according to some embodiments described herein.

FIG. 3 shows a flow diagram illustrating how a machine learning (ML) model may be trained to identify the areas corresponding to the bodies and the area corresponding to the body part of the people in the image of the environment as described herein.

FIG. 4 shows a flow diagram illustrating an example method that may be performed for detecting a body part in the image of the environment and determining an association between the body part and a human body in the environment as described herein.

FIG. 5A shows a flow diagram illustrating an example method for determining the association between the body part and the one of the people depicted in the image of the environment based on the center of the area that corresponds to the body part and the center of the area to which the vector points as described herein.

FIG. 5B shows a flow diagram illustrating an example method for determining the association between the body part and the one of the people depicted in the image of the environment based on respective classification labels for the area that corresponds to the body part and the area to which the vector points as described herein.

FIG. 6 is a block diagram illustrating an apparatus in the example form of a computer system, within which a set or sequence of instructions may be executed to cause the machine to perform any one of the methodologies discussed herein.

### DETAILED DESCRIPTION

Identification and localization of objects may be performed using anchor-based or anchor-free approaches. With an anchor-based approach, anchor bounding boxes may be predefined at various scales and aspect ratios and used to predict object locations and sizes. These anchor boxes may act as reference points or templates for object localization and classification. However, the selection of anchor boxes may affect the detection accuracy, and managing multiple anchors at different positions, scales, and ratios can be computationally intensive. In contrast, anchor-free object detection methods may aim to directly predict bounding boxes and object locations without relying on predefined anchor boxes. For example, using a center-based approach, an object may be detected by predicting the center point of the object and its size, without the use of predefined anchors.

Anchor-free object detection methods may predict a 4D vector for each location within a bounding box that may represent distances from the location to the bounding box's sides and provide information about part-to-body associations. Embodiments of the present disclosure may leverage the information produced by anchor-free object detection and supplement it with a 2D vector, denoting the offset (e.g., in terms of distance and direction) from the center of a bounding box around a body part to the center of a corresponding body bounding box, thereby explicitly representing the part-to-body association (e.g., a one-to-one association) in a logical extension to anchor-free object detection methods. Using such a single part-to-body center offset allows for detection of any number of body parts without increasing the number of center offsets correspondingly (e.g., the approach is thus more scalable and avoids degrading the overall object detection performance when the number of objects increases). Furthermore, compared to methods that involve determining a “one-to-many” body-to-part correspondence, which may become invalid when some parts (e.g., of the many) are not visible, the approach described herein establishes a “one-to-one” correspondence between each body part and a body and therefore the part-to-body center offset is always valid, providing a well-defined ground truth for supervised training for machine learning. Still further, this one-to-one correspondence simplifies post-processing and provides more precise part-to-body associations.

It is noted that the examples provided herein may refer to human part-to-body association, but this merely serves as a representative example. The approach described herein may serve as a universal part-to-body association detection framework. For example, the approach described herein may be used to address various parts-to-body association challenges (e.g., the wheel-to-car association) without requiring significant modifications.

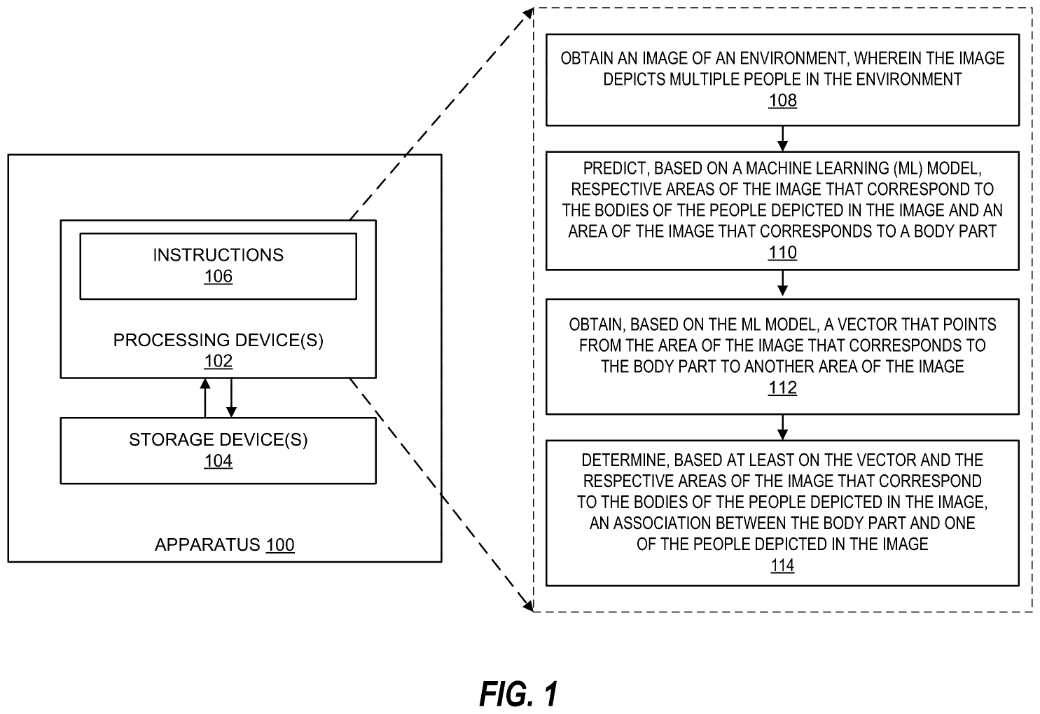

FIG. 1 shows a simplified block diagram of an example apparatus 100 that may be used to perform the operations for detecting bodies and a body part in an image of an environment and determining an association between the body part and one of the bodies as described herein.

Apparatus 100 may be a standalone computing system or a networked computing resource implemented in a computing cloud, and may include processing device(s) 102 and storage device(s) 104, where the storage device 104 may be communicatively coupled to processing device 102. Processing device(s) 102 may include one or more processors such as a central processing unit (CPU), a graphic processing unit (GPU), or an accelerator circuit. The storage device(s) 104 may include a memory device, a hard disc, and/or a cloud storage device connected to processing device 102 through a network interface card (not shown in FIG. 1). Processing device(s) 102 may be programmed to use historical data regarding the position of the object (e.g., obtained from storage device(s) 104 and/or some other storage device) to predict the position of the object over a time period, as described herein, via instructions 106.

The processing device(s) 102 may execute instructions 106 and perform the following operations for predicting the position of the object over a time period. At operation 108, the processing device(s) 102 may obtain (e.g., from an image sensor inside a medical scanner room) an image of an environment, wherein the image depicts multiple people in the environment. In an example scenario, a medical imaging system may infer instructions from detected hand gestures of a technician in the environment (e.g., a scanning or surgery room). Multiple visual sensors may be placed in (or near) the environment in order to capture images (RGB, depth, and/or IR images) of the environment (e.g., including multiple people such as the technician, a patient, etc.) which may then be analyzed to detect the hand gestures of the technician. These images may be obtained by the processing device(s) 102 and processed as described below.

At operation 110, the processing device(s) 102 may predict, based on a machine learning (ML) model, respective areas of the image that correspond to the bodies of the people depicted in the image and an area of the image that corresponds to a body part (e.g., the technician's hand). In some embodiments, the ML model may be implemented via an artificial neural network (ANN) such as a convolutional neural network (CNN). The CNN may be trained as a feature extractor and used (e.g., after the training) to obtain a feature vector or feature map representing the characteristics of the people and/or objects in the image. The areas of the image that correspond to the people and/or objects (e.g., body parts) may then be determined using a “detection head” (e.g., a decoder comprising multiple convolution layers) by predicting (e.g., using an anchor-free approach) a bounding box around each person or object in the image in accordance with the features extracted by the CNN. For example, Fᵢ∈ [symbol] ^{H}^{ᵢ}^{×W}^{ᵢ}^{×C}^{ᵢ} may represent a feature map at layer i∈{1, . . . , L} of a backbone CNN with sᵢ being the total stride up to that layer. Hᵢ, Wᵢ, and Cᵢ may be the height, width, and depth of the feature maps respectively, and L may be the number of layers whose feature maps are considered. A first sub-network may regress the bounding-box of each target and a second sub-network may classify the bounding boxes, e.g., to match the ground-truth targets T=(B, c), where B={xₗ, yₜ, xᵣ, y_{b}}∈ [symbol] ⁴ denotes the coordinates of the left-top and right-bottom corners of the bounding box, c∈{1, 2, . . . , N} specifies the class of the object within the bounding box, and N stands for the total number of classes. For example, N=4 when focusing on labeling the body, left hand, right hand, and face of people in the image of the environment. In some embodiments (e.g., using an anchor-free paradigm), detection may be formulated as a dense inference, e.g., in a per-pixel prediction fashion in feature maps. For each position pᵢ=(xᵢ, yᵢ) in Fᵢ, a detection head may regress a 4D vector (lᵢ, tᵢ, rᵢ, bᵢ), which may represent the relative offsets from the four sides of a bounding box containing pᵢ. Based on the relation

$$( {x}_{i} , {y}_{i} ) = ( ⌊ \frac{x}{{s}_{i}} ⌋ , ⌊ \frac{y}{{s}_{i}} ⌋ )$$

between feature map locations pᵢ and corresponding locations p=(x, y) in the original image, the predicted values may satisfy the following set of equations with respect to the ground-truth B:

$$⌊ \frac{{x}_{l}}{{s}_{i}} ⌋ = {x}_{i} - {l}_{i} , ⌊ \frac{{y}_{t}}{{s}_{i}} ⌋ = {y}_{i} - {t}_{i} , ⌊ \frac{{x}_{r}}{{s}_{i}} ⌋ = {x}_{i} + {r}_{i} , ⌊ \frac{{y}_{b}}{{s}_{i}} ⌋ = {y}_{i} + {b}_{i} \qquad ( 1 )$$

The points pᵢ may be selected from multi-level feature maps, which may aid in detecting objects of varying sizes and enhances the robustness of predictions. Similarly, a classification head returns a score vector o_{c}∈ [symbol] ^{N} with respect to each class for each position in the feature maps which may be used to predict (e.g., with a probability or confidence score) whether a pixel or voxel (e.g., position) of the input image of the environment is a part of a body of a person depicted in the image.

At operation 112, apparatus 100 may also obtain, based on the ML model, a vector that points from the area of the image that corresponds to the body part to another area of the image. For example, this vector may originate from the center of the body part bounding box and terminate at the center of the body bounding box to which the body part may belong. The vector may be predicted based on an inherent property of the anchor-free detection paradigm that a body part's bounding-box should also belong to the body's bounding box and therefore should satisfy the set of equations (1) for both sets of bounding parameters (e.g., body and body part). Therefore, the body part detection task may be extended to include not only predicting the 4D vector corresponding to the body part's own bounding box, but also the aforementioned vector (e.g., a second vector) pointing to the corresponding body's bounding box so as to establish an association between the body part and the corresponding body.

In order to achieve a more concise delineation of the part-to-body association, the second vector may be defined as the 2D center-to-center offset from the body part's bounding box to the body's bounding box (e.g., transitioning from a 4D vector to a 2D vector). Therefore, the ground-truth target described above may be extended so that T={B, c, c^{p}}∈ [symbol] ⁴×{1, 2, . . . , N}× [symbol] ², where c^{p}={cₓ^{b}, c_{y}^{b}} is the center of the bounding box of the body that encloses the bounding box of the body part. Accordingly, for a point within the body part's bounding box, a 2D vector (mᵢ, nᵢ) representing the offset from the point to the body center may be regressed to encode the part-to-body association. The 2D vector may satisfy the following:

$$⌊ \frac{{c}_{x}^{b}}{{s}_{i}} ⌋ = {x}_{i} + λ {m}_{i} , ⌊ \frac{{c}_{y}^{b}}{{s}_{i}} ⌋ = {y}_{i} + λ {n}_{i} \qquad ( 2 )$$

where λ is a scaling factor of mᵢ and nᵢ to control the range of the network outputs. With respect to the input image of the environment, per-position network predictions may be denoted as o={o_{b}, o_{c}, o_{d}}, where o_{b}={lᵢ, tᵢ, rᵢ, bᵢ} is the bounding box prediction, o_{c}={c₁, . . . , c_{N}} is the classification result (e.g., body, left hand, right hand, and face), and o_{d}={mᵢ, nᵢ} relates to the part-to-body association (e.g., 2D vector representing offset to body center).

The part-to-body association prediction may be performed over the multi-level feature maps described herein. For example, given the feature maps Fᵢ∈ [symbol] ^{H}^{ᵢ}^{×W}^{ᵢ}^{×C}^{ᵢ} produced by the backbone network as inputs, the detection head may include three distinct output branches. These branches may be responsible for bounding box prediction, class prediction, and part-to-body association prediction, respectively. Each branch may be constructed using a convolutional neural network (e.g., a three-layer sub-network), where the kernel sizes may be set to {3×3, 3×3, 1×1} and the stride may be set to 1. The bounding-box sub-network may have the channel structure

$$\{ {C}_{i} , ⌊ \frac{{C}_{i}}{4} ⌋ , ⌊ \frac{{C}_{i}}{4} ⌋ , 64 \}$$

and may be followed by a distribution focal loss (DFL) module to output O_{b}=∈ [symbol] ^{H}^{ᵢ}^{×W}^{ᵢ}^{×4} (e.g., a 2D map of o_{b} predictions), the class sub-network may adopt {Cᵢ, Cᵢ, Cᵢ, N} to output O_{c}∈ [symbol] ^{H}^{ᵢ}^{×W}^{ᵢ}^{×N}, and the part-to-body association sub-network may use

$$\{ {C}_{i} , ⌊ \frac{{C}_{i}}{4} ⌋ , ⌊ \frac{{C}_{i}}{4} ⌋ , 2 \}$$

to output O_{d}∈ [symbol] ^{H}^{ᵢ}^{×W}^{ᵢ}^{×2}.

At operation 114, the apparatus 100 may determine, based at least on the vector and the respective areas of the image that correspond to the bodies of the people depicted in the image, an association between the body part and one of the people depicted in the image. As noted above, the center offset between a body part and its corresponding body may serve as a link in the part-to-body relationship. During inference, the process may be initiated by filtering out overlapping predictions through non-maximum suppression (NMS). This may yield refined results for parts and bodies as follows:

$${\hat{O}}^{b} = NMS ( {O}^{b} , {τ}_{conf}^{b} , {τ}_{ion}^{b} ) , \qquad ( 5 )$$

$${\hat{O}}^{p} = NMS ( {O}^{p} , {τ}_{conf}^{p} , {τ}_{ion}^{p} ) ,$$

where τ_{conf}^{b}, τ_{conf}^{p}, τᵢₒᵤ^{b}, and τᵢₒᵤ^{p} represent the confidence and Intersection over Union (IoU) overlap thresholds for both the body and part in the NMS procedure. For each body part, its anticipated body center may be computed based on the relationship defined in equation (2) as follows:

$${\hat{c}}_{x}^{b} = {s}_{i} ( {x}_{i} + λ {m}_{i} ) , {\hat{c}}_{y}^{b} = {s}_{i} ( {y}_{i} + λ {n}_{i} ) \qquad ( 6 )$$

Finally, for each body part, the Euclidean ( [symbol] ₂) distance(s) between the center of the body part's bounding box and the centers of the bounding boxes of any bodies that are unassigned and whose bounding boxes also enclose the body part's bounding box may be determined. The body with the smallest distance to the body part may be chosen as the corresponding body for the body part.

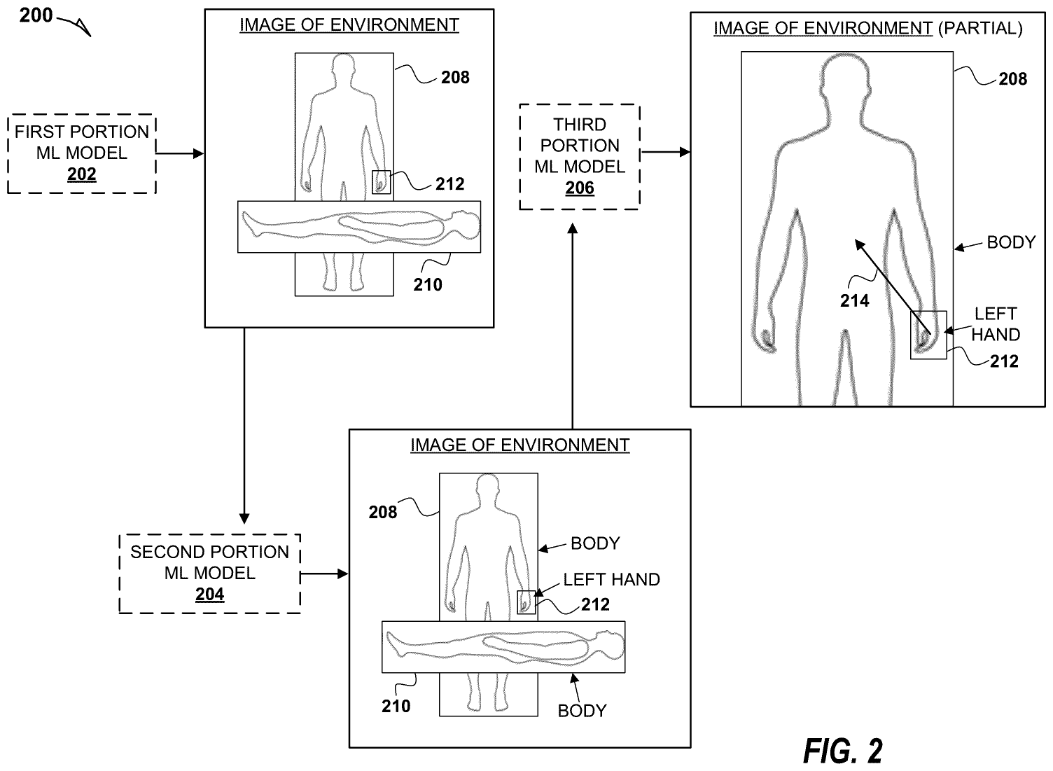

FIG. 2 shows a simplified diagram 200 illustrating how areas corresponding to a body part and areas corresponding to multiple bodies of people in the image of an environment may be identified and associated according to some embodiments described herein.

An image of the environment may comprise an image of a scanning room with a technician who is standing and a patient who is lying on a scanning bed. A scanner interface may, for example, accept visual instructions from gestures made by the left hand of the technician. As noted above, in some embodiments, an ML model used to determine the body part-to-body association may include a first portion 202, a second portion 204, and a third portion 206. The first portion 202 may be configured to determine the respective areas 208 and 210 of the image of the environment that correspond to the bodies of the people and the area 212 of the image of the environment that corresponds to the body part. The areas 208 and 210 of the image that correspond to the bodies of the people may include respective bounding boxes around the bodies of the people and the area 212 of the image that corresponds to the body part includes a bounding box around the body part. The second portion 204 may be configured to classify the areas 208, 210 and 212 determined by the first portion 202 (e.g., determine classification labels: body or left hand for each of the areas 208, 210 and 212). The third portion 206 may be configured to determine the vector 214 (e.g., a 2D vector) that points from the area 212 of the image (e.g., from the center of area 212) that corresponds to the body part to the other area of the image (e.g., the center of area 208) so that an association may be determined with respect to the body part (e.g., left hand) of area 212 and the body (e.g., of the technician) of area 208. Using the three portions of the ML model jointly, the part-to-body association task may be accomplished as a one-stage process, for example, by generating representations O^{b} and O^{p} for each detected body and body part, respectively, to represent the bounding box, classification label, and part-to-body center offset of each detected object (e.g., a body or a body part) in one prediction output. For instance, in the one body part (e.g., left hand) detection example shown in FIG. 2, the prediction output for the human body may be O^{b}=[B^{b}, L^{b}, C^{b}] and the prediction output for the left hand may be O^{p}=[B^{p}, L^{p}, C^{p}], where the B may represent a bounding box, L may represent a classification label (e.g., a value of 0 or 1), (may represent a part-to-body center offset (this field may be empty or zero for the human body since there is no offset between the human body and itself), and the superscripts b and p may represent body and body part, respectively. In this way, only one center offset needs to be defined for each object even if the association task involves multiple body parts (e.g., since the center offset or 2D vector is from each body part to the body), making the solution scalable for any number of body parts. As such, the solution may be different from conventional techniques that establish body-to-part associations from the body to the body parts and thus need to define multiple center offsets for each target object. The solution may also be distinguishable from the conventional techniques because it is a one-stage process (e.g., the bounding box, classification label, and center offset are predicted together), while the conventional techniques may perform the task via separate stages (e.g., detecting bounding boxes at a first stage and then calculating a similarity score between each pair of bounding boxes at a second stage). Therefore, the solution described herein may decrease the amount of computation needed and/or increase its efficiency.

As noted above, given the feature maps Fᵢ∈ [symbol] ^{H}^{ᵢ}^{×W}^{ᵢ}^{×C}^{ᵢ} produced by a backbone CNN as inputs, the detection head may include three distinct output branches. These branches may be responsible for bounding box prediction, class prediction, and part-to-body association prediction, respectively. Each branch may be constructed using a multi-layer (e.g., three-layer) convolutional network, where the kernel sizes may be set to {3×3, 3×3, 1×1} and the stride may be set to 1. The bounding-box sub-network may have the channel structure

$$\{ {C}_{i} , ⌊ \frac{{C}_{i}}{4} ⌋ , ⌊ \frac{{C}_{i}}{4} ⌋ , 64 \}$$

and may be followed by a DFL module to output O_{b}=∈ [symbol] ^{H}^{ᵢ}^{×W}^{ᵢ}^{×4} (e.g., a 2D map of o_{b} predictions), the class sub-network may adopt {Cᵢ, Cᵢ, Cᵢ, N} to output O_{c}∈ [symbol] ^{H}^{ᵢ}^{×W}^{ᵢ}^{×N}, and the part-to-body association sub-network may use

$$\{ {C}_{i} , ⌊ \frac{{C}_{i}}{4} ⌋ , ⌊ \frac{{C}_{i}}{4} ⌋ , 2 \}$$

to output O_{d}∈ [symbol] ^{H}^{ᵢ}^{×W}^{ᵢ}^{×2}.

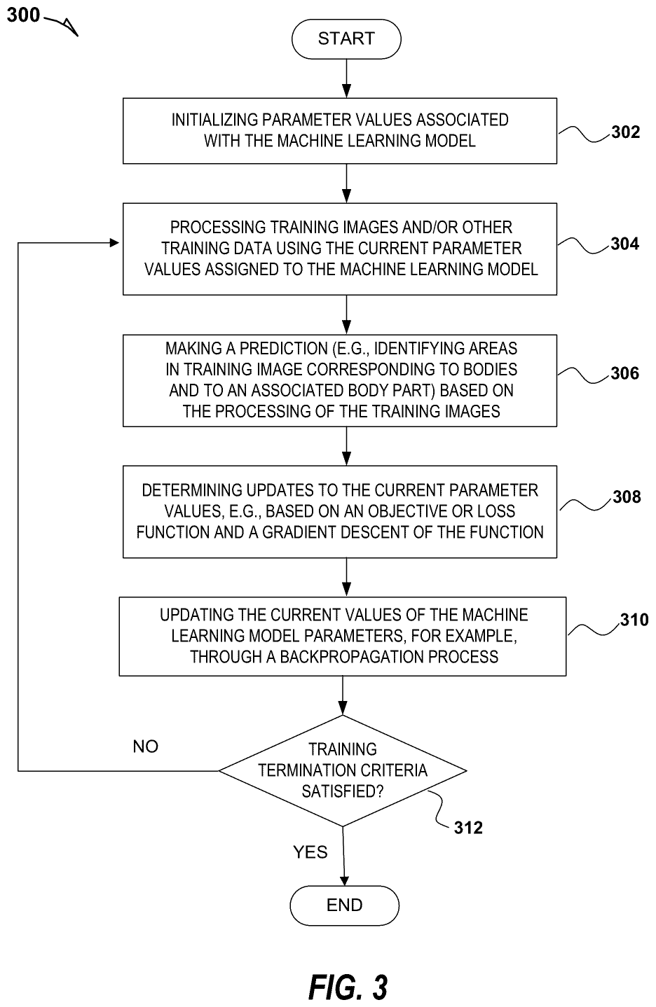

FIG. 3 shows a flow diagram 300 illustrating example techniques for training a machine learning (ML) model (e.g., implemented and/or learned using an artificial neural network) to perform the object detection and part-to-body detection tasks described herein.

The training process 300 may be performed by a system of one or more computers. At 302, the system may initialize the operating parameters of the machine learning model (e.g., weights associated with various layers of the artificial neural network used to implement the machine learning model). For example, the system may initialize the parameters based on samples from one or more probability distributions or parameter values associated with a similar machine learning model. At 304, the system may process training images and/or other training data, such as the captured images of a technician and a patient inside a medical scanning room, using the current parameter values assigned to the machine learning model. At 306, the system may make a prediction (e.g., identify areas in training image corresponding to bodies of individuals and an associated body part of one of the individuals) based on the processing of the training images.

At 308, the system may determine updates to the current parameter values associated with the machine learning model, e.g., based on an objective or loss function and a gradient descent of the function. As described herein, the objective or loss function may be designed to measure a difference between the prediction and a ground truth. The objective function may be implemented using, for example, mean squared errors, L1 norm, etc. associated with the prediction and/or the ground truth. For example, given the feature maps Fᵢ∈ [symbol] ^{H}^{ᵢ}^{×W}^{ᵢ}^{×C}^{ᵢ}, the part-to-body association detection branch of the ML model may produce an output O_{d}∈ [symbol] ^{H}^{ᵢ}^{×W}^{ᵢ}^{×2}, indicating that each anchor point yields a 2D vector. The anchor assignment for the part-to-body association may be based on an anchor alignment metric expressed as t=s^{α}·u^{β}, where s and u denote a classification score and an Intersection over Union (IoU) value respectively, and α and β are hyper-parameters used to control the impact of the two tasks over the anchor alignment metric t. Utilizing the proposed metric t, the top K anchor points may be chosen for supervision at each training step and the part-to-body association loss may then be articulated as:

$${ℒ}_{assoc} = \frac{1}{K} \frac{1}{P} {\sum }_{{j ∈ J}_{i ∈ \{ 1 , . , L \}}} \frac{1}{2} ( {‖ ⌊ \frac{{c}_{x}^{b} [ j ]}{{s}_{i}} ⌋ - ( {x}_{i} [ j ] + λ {m}_{i} [ j ] ) ‖}_{1} + {‖ ⌊ \frac{{c}_{y}^{b} [ j ]}{{s}_{i}} ⌋ - ( {y}_{i} [ j ] + λ {n}_{i} [ j ] ) ‖}_{1} ) , \qquad ( 3 )$$

with J representing the index list of the top K aligned anchor points for each part and P indicating the number of parts in the image. Therefore, the overall loss may be expressed as:

$$ℒ = {λ}_{iou} {ℒ}_{iou} + {λ}_{dfl} {ℒ}_{dfl} + {λ}_{cls} {ℒ}_{cls} + {λ}_{assoc} {ℒ}_{assoc} \qquad ( 4 )$$

wherein λᵢₒᵤ, λ_{dfl}, λ_{cls}, and λ_{assoc} are the objective-weighting hyper-parameters.

At 310, the system may update the current values of the machine learning model parameters, for example, by backpropagating the gradient descent of the loss function through the artificial neural network. At 312, the system may determine whether one or more training termination criteria are satisfied. For example, the system may determine that the training termination criteria are satisfied if the system has completed a pre-determined number of training iterations, or if the change in the value of the loss function between two training iterations falls below a predetermined threshold. If the determination at 312 is that the training termination criteria are not satisfied, the system may return to 304. If the determination at 312 is that the training termination criteria are satisfied, the system may end the training process 300.

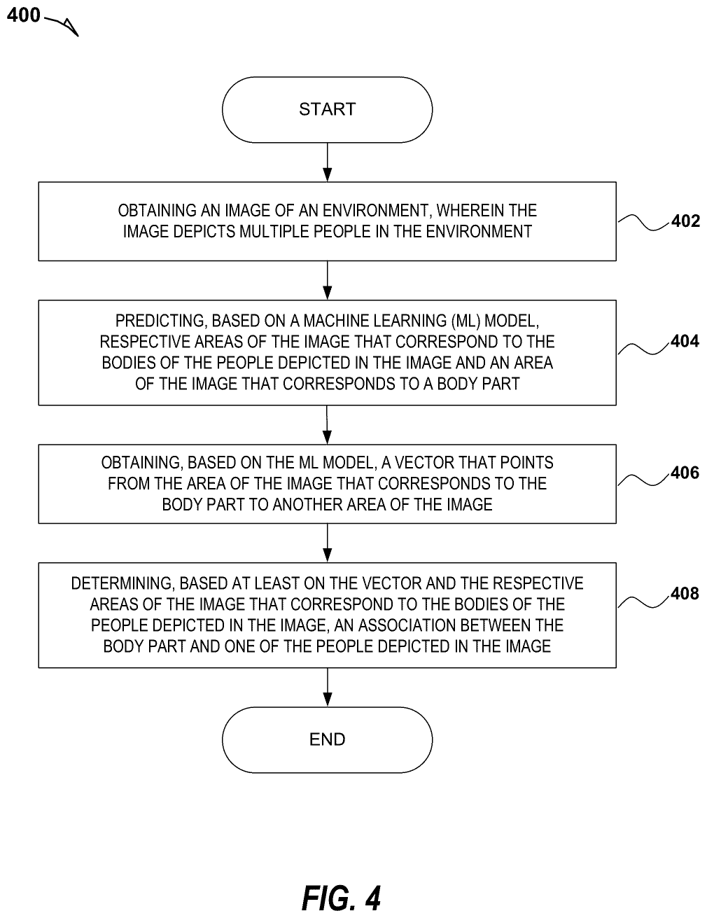

FIG. 4 shows a flow diagram illustrating an example method 400 that may be performed for detecting a body part in the image of the environment and determining an association between the body part and a human body in the environment as described herein.

The method 400 may start and then at operation 402, proceed to obtaining (e.g., from an image sensor inside a medical scanner room) an image of an environment, wherein the image depicts multiple people in the environment. As noted above, a medical imaging system may want to receive instructions via detecting hand gestures of a technician in the environment (e.g., a scanning or surgery room). Multiple visual sensors may be placed in (or near) the environment in order to capture images (RGB, depth, and/or IR) of the environment (e.g., including multiple people such as the technician, a patient, etc.) which may then be analyzed to detect the hand gestures of the technician. These images may be obtained by the processing device(s) 102 shown in FIG. 1 and processed as described herein.

At operation 404, the method may include predicting, based on a machine learning (ML) model, respective areas of the image that correspond to the bodies of the people depicted in the image and an area of the image that corresponds to a body part of one of the people (e.g., areas 208, 210 and 212 of FIG. 2). As described above, the ML model may be implemented via an artificial neural network (ANN) such as a convolutional neural network (CNN).

At operation 406, the method may further include obtaining, based on the ML model, a vector that points from the area of the image that corresponds to the body part to another area of the image and determine. As noted above, in the anchor-free approach, a point belonging to a body part's bounding-box should also belong to the body's bounding box and therefore should satisfy the set of equations (1) for both sets of bounding parameters (e.g., body and body part). Therefore, the body part detection task may be extended to include not only predicting the 4D vector corresponding to the body part's own bounding box, but also a second vector pointing to the corresponding body's bounding box. In order to achieve a more concise delineation of the part-to-body association, the second vector may be defined as the 2D center offset from the body part's bounding box to the body's bounding box.

At operation 408, the method may further include determining, based at least on the vector and the respective areas of the image that correspond to the bodies of the people depicted in the image, an association between the body part and one of the people depicted in the image. As noted above, the center offset between a body part and its corresponding body may serve as a link in the part-to-body relationship. For each body part, the Euclidean ( [symbol] ₂) distance(s) between the center of the body part's bounding box and the centers of the bounding boxes of any bodies that are unassigned and whose bounding boxes also enclose the body part's bounding box may also be determined. The body with the smallest distance to the body part may be chosen as the corresponding body for the body part. The method 400 may then end.

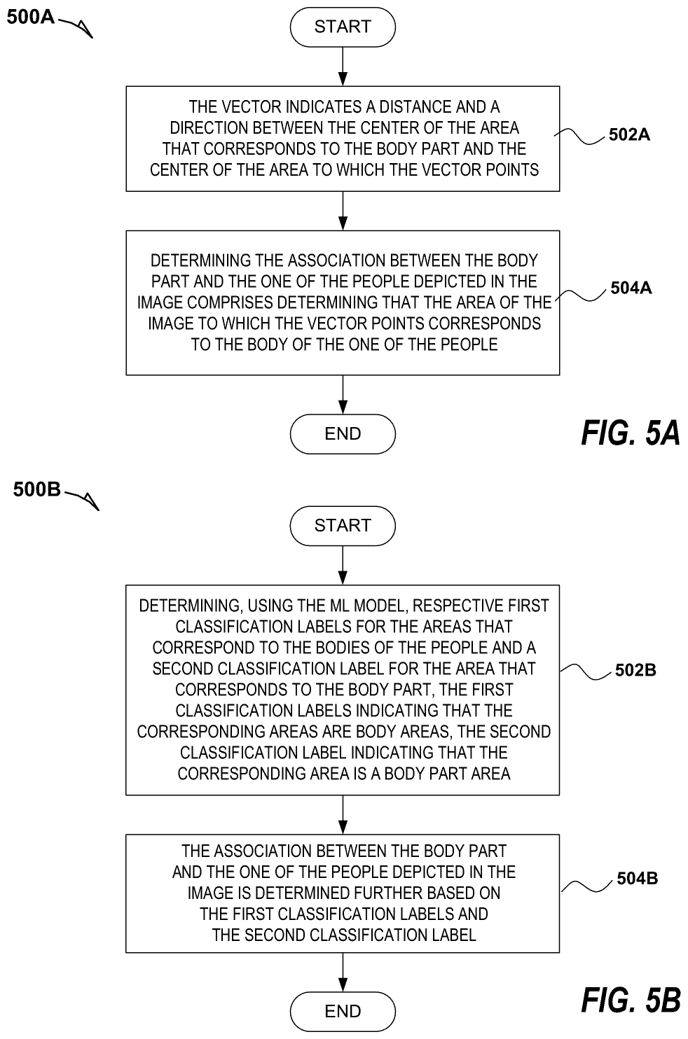

FIG. 5A shows a flow diagram illustrating an example method 500A for determining the association between the body part and the one of the people depicted in the image of the environment based on the center of the area that corresponds to the body part and the center of the area to which the vector points as described herein.

The method 500A may start and, at 502A, may proceed to obtaining the vector (e.g., vector 214 of FIG. 2) that indicates a distance and a direction between the center of the area that corresponds to the body part (e.g., area 212 of FIG. 2) and the center of the area to which the vector points (e.g., area 208 of FIG. 2). As noted above, the vector may be defined as the 2D center offset from the body part's bounding box to the corresponding body's bounding box.

At 504A, the method may include determining the association between the body part and the one of the people depicted in the image by determining that the area of the image, to which the vector points, corresponds to the body of the one of the people. For example, it may be determined that the body part of area 212 of FIG. 2 is associated with the body of area 208 of FIG. 2 (e.g., the body part is determined to be the left hand of the technician). The method 500A may then end.

FIG. 5B shows a flow diagram illustrating an example method 500B for determining the association between the body part and the one of the people depicted in the image of the environment based on respective classification labels for the area that corresponds to the body part and the area to which the vector points as described herein.

The method 500B may start and, at 502B, may proceed to determining, using the ML model, respective first classification labels (e.g., body) for the areas that correspond to the bodies of the people (e.g., areas 208 and 210 of FIG. 2) and a second classification label (e.g., face, left hand, right hand, etc.) for the area that corresponds to the body part (e.g., area 212 of FIG. 2) with the first classification labels indicating that the corresponding areas are body areas (e.g., corresponding to the technician or the patient in FIG. 2) and the second classification label indicating that the corresponding area is a body part area (e.g., corresponding to the left hand of the technician).

At 504B, the method may include determining the association between the body part and the one of the people depicted in the image further based on the first classification labels and the second classification label. For example, the association between the body part and the one of the people depicted in the image may be determined based on the area of the image to which the vector points being classified as a “body” of the one of the people. The method 500B may then end.

For simplicity of explanation, the operations of the methods (e.g., performed by apparatus 100 of FIG. 1) are depicted and described herein with a specific order. It should be appreciated, however, that these operations may occur in various orders, concurrently, and/or with other operations not presented or described herein. Furthermore, it should be noted that not all operations that the apparatus is capable of performing are depicted in FIGS. 3, 4 and 5A-5B or described herein. It should also be noted that not all illustrated operations may be required to be performed.

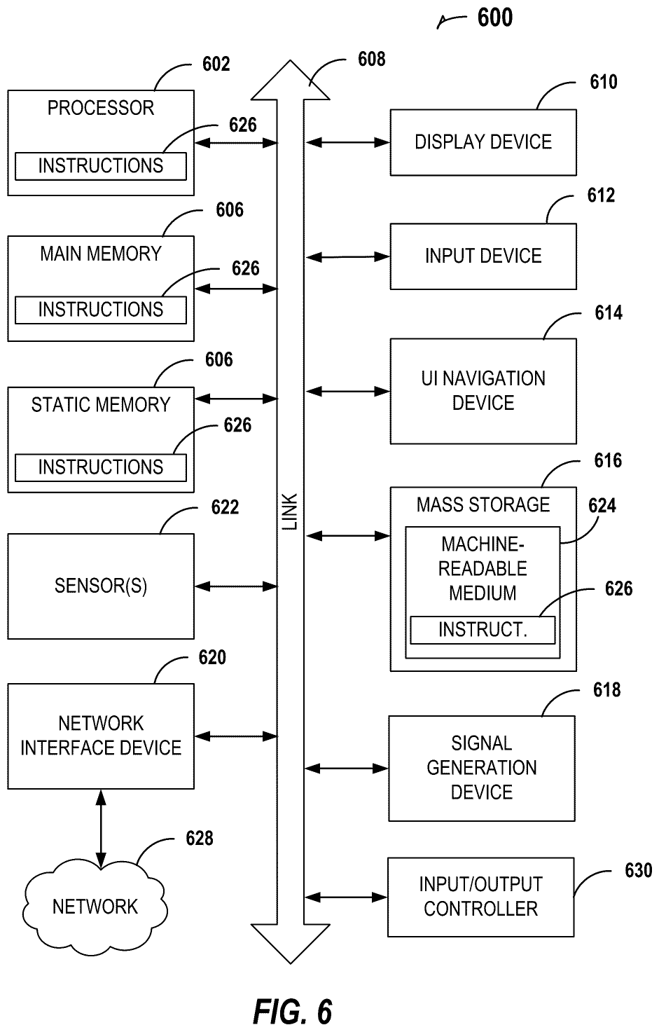

FIG. 6 is a block diagram illustrating an apparatus in the example form of a computer system 600, within which a set or sequence of instructions may be executed to cause the machine to perform any one of the methodologies discussed herein.

In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein (e.g., method 300 of FIG. 3, method 400 of FIG. 4 and methods 500A and 500B of FIGS. 5A-5B).

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors 622, such as a global positioning system (GPS) sensor, accelerometer, gyrometer, magnetometer, or other such sensor.

The storage device 616 includes a machine-readable medium 624 on which is stored one or more sets of data structures and instructions 626 (e.g., software) embodying or utilized by any one or more of the methodologies or functions described herein. The instructions 626 may also reside, completely or at least partially, within the main memory 604, static memory 606, and/or within the processor 602 during execution thereof by the computer system 600, with main memory 604, static memory 606, and the processor 602 comprising machine-readable media.

While the machine-readable medium 624 is illustrated in an example embodiment to be a single medium, the term “machine-readable medium” may include a single medium or multiple media (e.g., a centralized or distributed database, and/or associated caches and servers) that store the one or more instructions 626. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include volatile or non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 626 may further be transmitted or received over a communications network 628 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 16G LTE/LTE-A or WiMAX networks). The term “transmission medium” shall be taken to include any intangible medium that is capable of storing, encoding, or carrying instructions for execution by the machine, and includes digital or analog signals or other intangible medium to facilitate communication of such software.

Example computer system 600 may also include an input/output controller 630 to receive input and output requests from at least one central processor 602, and then send device-specific control signals to the device they control. The input/output controller 630 may free at least one central processor 602 from having to deal with the details of controlling each separate kind of device.

The term “computer-readable storage medium” used herein may include any tangible medium that is capable of storing or encoding a set of instructions for execution by a computer that cause the computer to perform any one or more of the methods described herein. The term “computer-readable storage medium” used herein may include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure. In addition, unless specifically stated otherwise, discussions utilizing terms such as “analyzing,” “determining,” “enabling,” “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

1. An apparatus, comprising:
one or more processors configured to:
obtain an image of an environment, wherein the image depicts multiple people in the environment;
predict, based on a machine learning (ML) model, respective areas of the image that correspond to the bodies of the people depicted in the image and an area of the image that corresponds to a body part;
obtain, based on the ML model, a vector that points from the area of the image that corresponds to the body part to another area of the image; and
determine, based at least on the vector and the respective areas of the image that correspond to the bodies of the people depicted in the image, an association between the body part and one of the people depicted in the image.

2. The apparatus of claim 1, wherein the vector indicates a distance and a direction between the center of the area that corresponds to the body part and the center of the other area to which the vector points.

3. The apparatus of claim 1, wherein the one or more processors being configured to determine the association between the body part and the one of the people depicted in the image comprises the one or more processors being configured to determine that the other area of the image that the vector points to corresponds to the body of the one of the people.

4. The apparatus of claim 1, wherein the areas of the image that correspond to the bodies of the people include respective bounding boxes around the bodies of the people, and wherein the area of the image that corresponds to the body part includes a bounding box around the body part.

5. The apparatus of claim 1, wherein the one or more processors are further configured to determine, based on the ML model, respective first classification labels for the areas that correspond to the bodies of the people and a second classification label for the area that corresponds to the body part, the first classification labels indicating that the corresponding areas are body areas, the second classification label indicating that the corresponding area is a body part area.

6. The apparatus of claim 5, wherein the association between the body part and the one of the people depicted in the image is determined further based on the first classification labels and the second classification label.

7. The apparatus of claim 1, wherein the ML model includes a first portion, a second portion, and a third portion, the first portion configured to determine respective bounding boxes around the areas of the image that correspond to the bodies of the people and the area of the image that corresponds to the body part, the second portion configured to generate respective classification labels for the bounding boxes determined by the first portion, the third portion configured to determine the vector that points from the area of the image that corresponds to the body part to the other area of the image that corresponds to the body part.

8. The apparatus of claim 7, wherein the ML model is configured to indicate the bounding boxes, the classification labels, and the vector in the same output.

9. The apparatus of claim 8, wherein the ML model is implemented via at least one convolutional neural network, wherein the CNN is configured to generate multi-scale feature maps associated with the image, and wherein the ML model is configured to predict the vector that points from the area of the image that corresponds to the body part to the other area of the image that corresponds to the body part based on the multi-scale feature maps.

10. The apparatus of claim 1, wherein the body part includes a hand.

11. A method for establishing a body part-to-body association, the method comprising:
obtaining an image of an environment, wherein the image depicts multiple people in the environment;
predicting, based on a machine learning (ML) model, respective areas of the image that correspond to the bodies of the people depicted in the image and an area of the image that corresponds to a body part;
obtaining, based on the ML model, a vector that points from the area of the image that corresponds to the body part to another area of the image; and
determining, based at least on the vector and the respective areas of the image that correspond to the bodies of the people depicted in the image, an association between the body part and one of the people depicted in the image.

12. The method of claim 11, wherein the vector indicates a distance and a direction between the center of the area that corresponds to the body part and the center of the other area to which the vector points.

13. The method of claim 11, wherein determining the association between the body part and the one of the people depicted in the image comprises determining that the other area of the image that the vector points to corresponds to the body of the one of the people.

14. The method of claim 11, wherein the areas of the image that correspond to the bodies of the people include respective bounding boxes around the bodies of the people, and wherein the area of the image that corresponds to the body part includes a bounding box around the body part.

15. The method of claim 11, further comprising determining, using the ML model, respective first classification labels for the areas that correspond to the bodies of the people and a second classification label for the area that corresponds to the body part, the first classification labels indicating that the corresponding areas are body areas, the second classification label indicating that the corresponding area is a body part area.

16. The method of claim 15, wherein the association between the body part and the one of the people depicted in the image is determined further based on the first classification labels and the second classification label.

17. The method of claim 11, wherein the ML model includes a first portion, a second portion, and a third portion, the first portion configured to determine respective bounding boxes around the areas of the image that correspond to the bodies of the people and the area of the image that corresponds to the body part, the second portion configured to generate respective classification labels for the bounding boxes determined by the first portion, the third portion configured to determine the vector that points from the area of the image that corresponds to the body part to the other area of the image that corresponds to the body part, and wherein the ML model is configured to indicate the bounding boxes, the classification labels, and the vector in the same output.

18. The method of claim 11, wherein the ML model is implemented via at least one convolutional neural network (CNN), the CNN is configured to generate multi-scale feature maps associated with the image, and the ML model is configured to predict the vector that points from the area of the image that corresponds to the body part to the other area of the image based on the multi-scale feature maps.

19. The method of claim 11, wherein the body part includes a hand.

20. A non-transitory computer-readable medium comprising instructions that, when executed by a processor included in a computing device, cause the processor to implement the method of claim 11.
